(19) United States
(12) Patent Application Publication
(10) Pub. No.: US 2024/0386174 A1
(43) Pub. Date: Nov. 21, 2024

(54) TEST VECTOR LEAKAGE ASSESSMENT ON HARDWARE IMPLEMENTATIONS OF ASYMMETRIC CRYPTOGRAPHY ALGORITHMS

(71) Applicant: University of Florida Research Foundation, Incorporated, Gainesville, FL (US)

(72) Inventors: Prabhat Mishra, Gainesville, FL (US); Emma Andrews, Gainesville, FL (US); Jayasena Ranhotige, Gainesville, FL (US)

(21) Appl. No.: 18/667,408

(22) Filed: May 17, 2024

Related U.S. Application Data
(60) Provisional application No. 63/467,784, filed on May 19, 2023.

(51) Int. Cl. G06F 30/3308; G06F 21/55; G06F 30/333

(52) U.S. Cl. CPC G06F 30/3308; G06F 21/556; G06F 30/333

(57) ABSTRACT

Embodiments provide for side-channel leakage evaluation of asymmetric key cryptography algorithms. An example method includes identifying inputs, constraints, and a sequence of steps involved in an algorithm of a design specification; generating input test vectors, wherein the input test vectors are associated with a secrecy guarantee of the algorithm; generating a testbench for simulation of the design specification; generating power traces by simulating the design specification; performing a leakage assessment on generated power profiles; generating a divergence factor; and determining whether the design specification has a side-channel vulnerability.

### CROSS-REFERENCE TO RELATED APPLICATIONS

The present application claims priority to U.S. Provisional Ser. No. 63/467,784, titled “TEST VECTOR LEAKAGE ASSESSMENT ON HARDWARE IMPLEMENTATIONS OF ASYMMETRIC CRYPTOGRAPHY ALGORITHMS,” filed May 19, 2023, the contents of which are incorporated by reference herein in their entirety.

### STATEMENT REGARDING GOVERNMENT FUNDING

This invention was made with government support under 1908131 awarded by the National Science Foundation. The government has certain rights in the invention.

### BACKGROUND

Symmetric cryptography, also known as secret-key cryptography, relies on a single key to perform encryption and decryption. It is easy to implement but the key distribution is a major concern. In contrast, asymmetric cryptography, also known as public-key cryptography, uses a pair of keys (public, private) for authentication or authenticated encryption. When encrypting a message with asymmetric cryptography, the public key is used by the sender for encryption. The private key is used by the recipient during decryption. This eliminates the practical limitation of key distribution in symmetric cryptography. There are also hybrid systems that utilize both symmetric and asymmetric cryptography, such as Elliptic Curve Integrated Encryption Scheme (ECIES). There are various efforts to perform side-channel leakage analysis of symmetric-key cryptosystems using Test Vector Leakage Assessment (TVLA). Unfortunately, the existing TVLA methods are not applicable for evaluating asymmetric key cryptosystems. It is important to evaluate the side-channel vulnerability of asymmetric key cryptography algorithms to design trustworthy systems.

### SUMMARY

Embodiments herein provide for an improved test vector leakage assessment (TVLA) technique for asymmetric key cryptography algorithms. Embodiments herein evaluate the applicability of existing TVLA techniques on asymmetric algorithms and identified the fundamental limitations. A systematic test generation technique is described herein to generate valid test cases that can maximize the switching difference in side-channel vulnerable implementations. Embodiments herein provide for a differential power analysis technique for asymmetric key cryptography algorithms. A partition-based t-test evaluation technique is presented herein to evaluate with higher statistical accuracy while preserving timing information over the traces.

The above summary is provided merely for purposes of summarizing some example embodiments to provide a basic understanding of some aspects of the present disclosure. Accordingly, it will be appreciated that the above-described embodiments are merely examples and should not be construed to narrow the scope or the spirit of the present disclosure in any way. It will be appreciated that the scope of the present disclosure encompasses many potential embodiments in addition to those here summarized, some of which will be further described below. Other features, aspects, and advantages of the subject matter will become apparent from the description, the drawings, and the claims.

### BRIEF DESCRIPTION OF THE FIGURES

Having thus described certain example embodiments of the present disclosure in general terms above, non-limiting and non-exhaustive embodiments of the subject disclosure will now be described with reference to the accompanying drawings which are not necessarily drawn to scale. The components illustrated in the accompanying drawings may or may not be present in certain embodiments described herein. Some embodiments may include fewer (or more) components than those shown in the drawings. Some embodiments may include the components arranged in a different way:

FIG. 1 depicts test vector leakage assessment (TVLA) steps for symmetric-key cryptosystems.

FIG. 2 depicts an example architecture of an improved test vector leakage assessment (referred to herein as “TVLA” without limitation) system for leakage assessment of asymmetric key cryptography hardware implementations, in accordance with embodiments of the present disclosure.

FIG. 3 depicts example stages in ECIES encryption, for use with embodiments herein.

FIG. 4 depicts a switching activity time-series diagram for an ECIES algorithm in accordance with embodiments herein.

FIGS. 5A and B depict example SPA test results for a Double-and-add Verilog implementation, in accordance with embodiments herein.

FIG. 6 depicts an example scenario for dynamic partitioning of traces based on the bitwise difference of an input nonce, in accordance with embodiments herein.

FIGS. 7A and 7B depict example SPA test results for a Double-and-add with two nonce (k) values, in accordance with embodiments herein.

FIG. 8 depicts example dynamic partitioning of trace data for the nonce size of 192 on the Montgomery scalar multiplication algorithm, in accordance with embodiments herein.

FIG. 9 depicts minimum p-value observed for partitioned Welch t-test DPA analysis for 1000 pairs of input vectors over different scalar multiplication algorithms.

FIGS. 10A and 10B depict example leakage locations and failed tests, in accordance with embodiments herein.

FIG. 11 depicts an example firmware-level evaluation of an ECC implementation, in accordance with embodiments herein.

FIG. 12 depicts example minimum p-value for partitioned Welch t-test DPA analysis on the firmware-level ECC implementation for 1000 pairs of input vectors over various scalar multiplication algorithms, in accordance with embodiments herein.

FIG. 13 depicts example minimum p-value for partitioned Welch t-test DPA analysis on the RSA implementation for 1000 pairs of input vectors over various RSA implementation algorithms, in accordance with embodiments herein.

FIG. 14 depicts example operations performed in accordance with embodiments herein.

FIG. 15 provides an example overview of a system that can be used to practice embodiments of the present disclosure.

FIG. 16 provides an example computing entity in accordance with some embodiments discussed herein.

FIG. 17 provides an example external computing entity in accordance with some embodiments discussed herein.

### DETAILED DESCRIPTION

Various embodiments of the present disclosure are described more fully hereinafter with reference to the accompanying drawings, in which some, but not all embodiments of the present disclosure are shown. Indeed, the present disclosure may be embodied in many different forms and should not be construed as limited to the embodiments set forth herein; rather, these embodiments are provided so that this disclosure will satisfy applicable legal requirements. The term “or” is used herein in both the alternative and conjunctive sense, unless otherwise indicated. The terms “illustrative” and “example” are used to be examples with no indication of quality level. Terms such as “computing,” “determining,” “generating,” and/or similar words are used herein interchangeably to refer to the creation, modification, or identification of data. Further, “based on,” “based at least in part on,” “based at least on,” “based upon,” and/or similar words are used herein interchangeably in an open-ended manner such that they do not indicate being based only on or based solely on the referenced element or elements unless so indicated. Like numbers refer to like elements throughout.

Test vector leakage assessment (TVLA) evaluates the side-channel leakage of sensitive information from the hardware implementation of a design. While TVLA for symmetric cryptography has been well studied, it is not applicable to asymmetric cryptography algorithms. Asymmetric-key algorithms involve complex computations in multiple stages that can lead to varying trace lengths depending on input parameters and associated constraints. Embodiments herein provide an effective TVLA technique for asymmetric-key cryptosystems that can compare lengthy trace data with a good statistical resolution and generate valid input (test) patterns to satisfy specific constraints.

Embodiments herein provide for an improved test vector leakage assessment (TVLA) technique for asymmetric key cryptography algorithms. For the purposes of clarity, embodiments herein may be referred to as TVLA but should not be considered to be limited to TVLA according to other existing TVLA techniques (and when other or existing TVLA techniques are described, they will be identified as such); that is, embodiments herein may be referred to TVLA but they are not to be considered limited to existing TVLA techniques without improvements described herein. Embodiments herein evaluate the applicability of existing TVLA techniques on asymmetric algorithms and identified the fundamental limitations. A systematic test generation technique is described herein to generate valid test cases that can maximize the switching difference in side-channel vulnerable implementations. Embodiments herein provide for a differential power analysis technique for asymmetric key cryptography algorithms. A partition-based t-test evaluation technique is presented herein to evaluate with higher statistical accuracy while preserving timing information over the traces.

Embodiments herein can produce valid test patterns to maximize the power signature differences. Example partition-based differential power analyses herein can significantly improve the TVLA accuracy. Extensive evaluation using elliptic curve cryptography algorithms demonstrates that the proposed TVLA framework can handle type 1 and type 2 statistical errors and evaluate hardware implementations of asymmetric cryptography algorithms with a statistical confidence of 99.999%.

### A. State-of-the-Art and Limitations

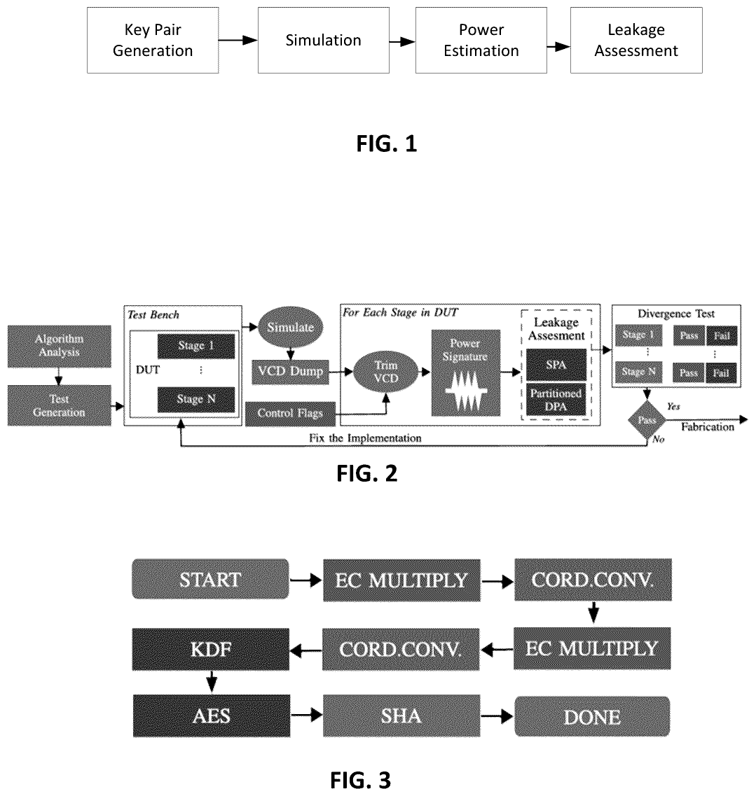

The intuition behind TVLA of hardware implementations is to provide a certain guarantee that the implementation does not reveal secrets through power side-channel signatures during execution. FIG. 1 illustrates the major steps involved in TVLA of symmetric key cryptography algorithms. The first step performs hamming distance-based test generation to produce differences in power signature. Next, the design is simulated with the generated key pairs and a fixed plaintext. The power signature is constructed based on the simulation's value change dump (VCD). Next, the difference between two power signatures is calculated using statistical methods, such as t-test and Kullback-Leibler (KL) divergence. Finally, the implementation is categorized as safe or side-channel vulnerable based on a pre-determined threshold. While this method works well on symmetric cryptosystems, it is not applicable on asymmetric cryptosystems due to the following fundamental challenges associated with asymmetric-key algorithms:
Involves complex computations that lead to significantly longer trace data compared with symmetric cryptography.
Implementations without timing mitigation can lead to varying trace lengths, while existing TVLA techniques expect fixed-length traces or manual trace alignments.
Timing-specific information such as specific places the power peak has occurred are not captured by applying the standard Welch t-tests and KL-divergence based methods.
Evaluation of asymmetric cryptography needs to consider side-channel leakage of multiple stages independently.
Input parameters and associated constraints are significantly different from symmetric cryptography.

Embodiments herein address the aforementioned drawbacks and more by evaluating the divergence between two traces with higher resolution by partitioning the traces of each stage and evaluating each partition independently. Embodiments herein resize the traces for each stage over the time axis to the same length using control flags to address the second challenge. Embodiments herein also utilize the control flags to automatically identify each stage of the implementation and perform leakage assessment separately for each stage focusing on security guarantees of the particular stage to address the fourth challenge. Finally, embodiments herein provide for an automated test generation framework to address the fifth challenge. By providing a TVLA framework focused on asymmetric key cryptography algorithms, embodiments herein provide for evaluation of systems consisting of both symmetric and asymmetric components.

### A. Elliptic Curve Cryptography

Elliptic curves are special plane curves over a field, primarily using Galois fields. All operations are done modulo p, where p is the value of the prime for the defined prime curve. Due to this, elliptic curves make a strong choice for usage in asymmetric cryptography. Elliptic curve cryptography (ECC) is the set of algorithms that use elliptic curves to provide a security guarantee, such as authentication through signatures or encryption and decryption. While the requirement for an elliptic curve is to use a prime number, when making security considerations this should be a large enough number to create certain security guarantees. Therefore, standardized curves from NIST, SEC, and other sources have been deemed secure for standardized usage.

RSA is the oldest and most popular choice for asymmetric key cryptography algorithms due to its simplicity and establishment in legacy programs. In order to have better security over RSA, points on the curve are used as the numbers to perform operations over for ECC. A point is on the curve and thus valid if it satisfies the elliptic curve equation. There are several different coordinate representations for an elliptic curve point. For brevity, embodiments herein only consider operating on affine coordinate points and Jacobian coordinate points. The affine representation of a point is (X, Y) and is the general representation of an elliptic curve point. Jacobian representation is (X, Y, Z). An affine point in Jacobian form is (X, Y, 1). The Z coordinate in Jacobian representation stores all the divisions that take place throughout any mathematical operations performed to the point. Algorithm 1 converts Jacobian projective coordinates to the equivalent affine coordinates.

### B. Vulnerabilities of Asymmetric-Key Cryptography

Asymmetric-key cryptography algorithms consist of multiple functions. The vulnerability analysis needs to check for vulnerabilities in each function. For example, the ECC module consists of various submodules, such as scalar multiplication and coordinate conversion. Let us take the example of scalar multiplication to illustrate the vulnerabilities. With elliptic curves, scalar multiplication is the equivalent of repeated additions of a point on the curve. However, the operation is dependent on the value of a bit in the scalar. ECC uses the private key as the scalar to generate the public key. Therefore, one of the scalar multiplications performed during an ECC algorithm is dependent on the value of the private key. As seen in Algorithm 2, if the current bit of the private key is a value of 1, an extra computation step must be performed. The extra computation step allows an attacker to analyze the power traces for increased use of power to perform this operation, recovering the private key. A similar notion of branching operations with different computational requirements based on the bit value of the private key is also present in RSA and other asymmetric cryptographic algorithms.

### C. Attacks on Asymmetric Key Cryptography

Cryptographic algorithms typically have some control flow dependency as part of their operations. While this is inherently secure, it does pose a security risk if the control flow depends on some secret information, such as the private key. An attacker can then carry out side-channel attacks on the implementation to retrieve a complete or partial private key, effectively exposing secret information. Minerva is an example of a recent attack on the scalar multiplication implementations of open-source software libraries that used lattices in conjunction with other leakage information to recover the private key. A projective to affine coordinate conversion attack on elliptic curve cryptography has been proposed. Modern ECC software implementations were detected with the vulnerability of projective coordinate leakage, showing the feasibility of recovering the private key completely through side-channel analysis. This also illustrated the need for a side-channel leakage assessment of cryptographic implementations.

### D. Collisions in Asymmetric Cryptographic Algorithms

In cryptography, collision attacks are primarily used with breaking hashing algorithms. These collision attacks work by making different inputs result in the same output, which can be used to reveal details of the internal algorithm, effectively reverse-engineering it. For algorithms like elliptic curve digital signature algorithm (ECDSA), secret information can be linked to certain steps of the computation. Since ECC implementations can be attacked using side-channels, combining side-channel attacks with collision attacks creates a new attack vector. This attack vector is known as horizontal collision correlation analysis. The classic side-channel attacks are thus distinguished as vertical attacks. Power analysis detects spots where collisions occur during the internal computations of point addition and point doubling. These two operations are important due to their usage in scalar multiplication, where the private key is multiplied by a fixed elliptic curve point. After gathering observations on the intermediate registers, Pearson's coefficient is used to derive the secret key.

### E. Limitations of Existing Side-Channel Leakage Assessment

Existing TVLA methods are suitable for symmetric key cryptography algorithms. However, the existing methods are not applicable on asymmetric key cryptography algorithms for the following reasons.

Validity of Inputs: There are multiple parameters as inputs to the asymmetric cryptography algorithms and not all possible inputs are valid inputs to the algorithm. For example, some techniques generate key pairs and random plaintext messages, but authenticated encryption algorithms like ECIES do not have inputs for secret keys, instead, it accepts public key, which is not a secret and a specific point on an ECC curve. Moreover, generating random inputs is not an option since this may lead to invalid states. A set of guidelines for generating test vector pairs for Elliptic Curve Digital Signature Algorithm (ECDSA) with possible collision attacks has been discussed.

Computing in Multiple Stages: Asymmetric cryptography is a sequential process, where certain steps need to be performed to complete the encryption/decryption or sign/verify process. These steps are supposed to preserve secrecy guarantee on different input parameters, such as nonce, coordinate points, Enc/Dec_Key, etc. This requirement is also not addressed by existing TVLA techniques.

Long Execution Traces: Statistical techniques such as Welch t-tests and KL divergence are directly used to perform the differential power analysis of power signature traces. This works with symmetric key cryptography algorithms since these algorithms perform block-wise operations. In fact, Hamming distance-based input key pairs can perform well with block-wise operations. Divergent values for the traces are calculated for a small number of clock cycles since the clock cycle depth for block cipher algorithms is significantly lower (order of 100) than asymmetric cryptography algorithms (order of 10000). The direct application of Welch t-tests and KL divergence techniques can hide small but important variations in the traces of asymmetric cryptography algorithms which defeats the purpose of TVLA.

Diversity of Algorithms: There are various types of algorithms proposed for the implementations of asymmetric cryptography with different objectives (security, speed, area, power, etc.). These algorithms have different computation times. In fact, there are algorithms that take different computation times based on the input values. This will lead to incorrect assessment.

### EXAMPLE EMBODIMENTS

FIG. 2 provides an overview of an example TVLA framework, in accordance with embodiments herein. The example TVLA framework can be used for side-channel leakage evaluation of asymmetric key cryptography algorithms that consists of five major tasks. The first task analyzes the design specification to identify the sequence of steps involved in the algorithm as well as different inputs and associated constraints. The second task generates input (test) vectors focusing on the secrecy guarantee of the algorithm followed by instrumentation of the testbench for simulation. The third task simulates the design to obtain the power traces. The fourth task performs the leakage assessment on generated power profiles using both simple and differential power analysis. The last task computes the divergence factor to identify if the implementation has a side-channel vulnerability.

### A. Design Specification

A major architectural difference between asymmetric and symmetric cryptography algorithms is the sequence of independent stages involved in them. Since the functionality of each stage is different, each stage is expected to have different power signatures during execution. FIG. 3 shows the seven stages to encrypt a message with the public key using ECIES: (i) elliptic curve multiplication, (ii) coordinate conversion step from projective to affine, (iii) elliptic curve multiplication, (iv) projective to affine coordinate conversion step, (v) key derivation (ICDF) step with ANSI-X9.63, (vi) encryption stage with AES, and (vii) generation of message authentication code with HMAC-SHAT. The ECIES decryption algorithm also follows several stages in order to successfully decrypt the message. The secrecy guarantee of each stage can be evaluated or analyzed based on the feasible vertical and horizontal collisions that can be manipulated with inputs to the algorithm. Next, the input constraints need to be analyzed, such as supported curves by the algorithm, which are considered during the test generation step.

### B. Test Generation

The objective of test generation is to produce multiple pairs of input vectors such that it maximizes the difference in the power signature of the same implementation. Depending on the asymmetric cryptography algorithms, the inputs are different. For example, Table I illustrates types of inputs for different ECC algorithms. Since there are diverse input parameters for different algorithms, each and every input parameter needs to be considered during the test generation.

The nonce is a major secrecy feature that needs to be evaluated based on the attacks discussed herein. A potential place the leakage can happen with nonce is the scalar multiplication stage. EC MULTIPLY stage is a bit serialized algorithm over the nonce. Therefore, generating patterns with multiple blocks of ‘0’s and ‘1’s in the nonce is the focus (e.g., using Algorithm 3). First, it generates a nonce with serialized block patterns of ‘0’s and ‘1’s and fills the rest of the requirements with random nonce values. The same algorithm can be used to generate private key pairs.

When providing inputs for the public key, point coordinates P(x, y, z) should be provided. In this case, the points should be valid points on the curve; otherwise, the algorithm ends up in an undefined state. For this, public keys are generated by solving the polynomial related to the curves identified herein. Next, multiple random plaintext messages are generated. Finally, each of these parameters is combined into the test vector following the steps outlined in Algorithm 4. First, the algorithm iterates through all the generated keys by solving the polynomial. For each key, random plaintext message is generated. Next, a test vector pair is generated such that the first and second nonce values (generated by Algorithm 3) append to the first and second tests of the test pair. If there are X public keys, Algorithm 3 will produce a total of X×N pairs of test vectors. In order to obtain more accurate results, the design is synthesized. Finally, a testbench is created to simulate the implementation with generated input test vectors.

### C. Simulation for Generation of Power Signatures

The testbench is simulated to generate a Value Change Dump (VCD). The power signature is generated from the obtained VCD data that corresponds to one test vector. Generally, side-channel footprints related to the power of hardware designs are correlated with the following factors:
Switching Activity of the internal signals of the device. Here transition of a signal from 0->1 and 1->0 are considered to consume more power and emanate more electromagnetic radiation compared to 0->0 and 1->1.
Hamming Weight power model correlates the number of signals that are either in value 0 or 1 in an instance to the overall power consumption of the device at that point.

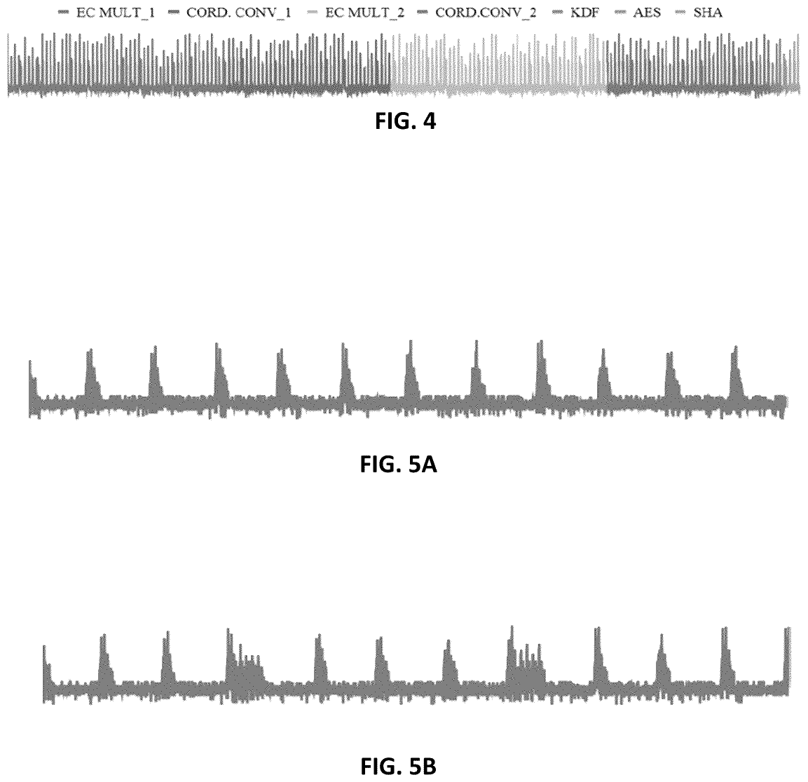

In order to identify the independent stages described herein, the control flag signals of the implementation are monitored. In this way, the leakage assessment can be performed in each stage of the implementation separately. FIG. 4 shows the power signature obtained during ECIES encryption divided into seven different stages with different colors. It is clear that ECC-related calculations, such as MULTIPLY (with Double-and-Add) and coordinate conversion (CORD.CONV), occupy the vast majority of the computation. The next two sections perform the leakage assessment on the generated power signatures for each stage of the implementation separately. Utilization of control flags leads to automatic power signature alignment for the leakage assessment.

### D. Leakage Assessment Using Simple Power Analysis (SPA)

Simple Power Analysis (SPA) analyzes execution traces without any pre-processing. SPA can reveal information about the device's internal states, algorithm structure, and input-dependent power variations. Since algorithms are known, attackers can infer the idea about internal operations and secret data by analyzing a single trace or pair of traces. Implementations that appear to be safe against SPA should be further evaluated with differential power analysis.

Example: Scalar multiplication, Double-and-Add, is illustrated in Algorithm 2. Analyzing the steps involved in the algorithm, it can be observed that the operations performed over the bit value of the scalar (k) is different for bit=0 and bit=1. Without having any prior knowledge about the nonce, by looking at the power traces, multiple different power levels consumed by the device during the operations can be observed. FIGS. 5A and 5B illustrate the two power signatures constructed for an implementation using Algorithm 2. For two key values of k=0xF0F0F (FIG. 5B) and k=0xFFFF (FIG. 5A), it shows a significant difference in the power peaks, which makes the implementation fail the SPA test.

### E. Leakage Assessment Using Differential Power Analysis

Differential Power Analysis (DPA) utilizes statistical-based techniques to identify data-dependent correlations. As the name suggests, DPA requires more than one trace to perform the comparison, and hence test vector pairs are generated herein. As discussed herein, for the same stage of the algorithm, two power signature traces can be of different lengths due to the variation of execution time with the inputs. In order to address the problem of variable finish time of algorithms, the traces are resized into the same length with interpolated transformation. To preserve timing information for statistical analysis, both traces are partitioned into C equal sizes and differential analysis is performed on each part separately. This preserves the timing information in the traces across the partitions and generalizes the evaluation technique to all the algorithms. Next, the statistical Welch t-test method is applied on each partition to two partitions of the power traces are evaluated to assess their differences.

Considering a pair of traces T(v₁ⁱ,Sₖ) and T(v₂ⁱ,Sₖ), collected over stage Sₖ for the input test vector pair

$${V}^{i} = \{ {v}_{1}^{i} , {v}_{2}^{i} \} . Let {n}_{{v}_{j}^{i}} , {μ}_{{v}_{j}^{i}} , and {s}_{{v}_{j}^{i}}^{2}$$

be the size, mean, and variance of the x^{th} partition of trace T(vⱼⁱ,Sₖ), then Welch t-test t for T(v₁ⁱ,Sₖ)^{x} and T(v₂ⁱ,Sₖ)^{x} trace partitions can be computed by Equation 1 (with a corresponding p value in Equation 2).

$$t = \frac{{μ}_{{v}_{1}^{i}} - {μ}_{{v}_{2}^{i}}}{\sqrt{\frac{{s}_{{v}_{1}^{x}}^{2}}{{n}_{{v}_{1}^{i}}} - \frac{{s}_{{v}_{2}^{x}}^{2}}{{n}_{{v}_{2}^{i}}}}} \qquad ( 1 )$$

$$p = 2 {\int }_{\vert t \vert}^{∞} f ( t , d ) dt \qquad ( 2 )$$

where d represents a degree of freedom.

$${( 1 - {α}^{′} )}^{C} = ( 1 - α ) \qquad ( 3 )$$

$${α}^{′} = 1 - {( 1 - α )}^{\frac{1}{C}}$$

$${α}^{′} = \frac{α}{c}$$

For the t-test, the null hypothesis is set as T(v₁ⁱ,Sₖ) and T(v₂ⁱ,Sₖ) traces are drawn from the same population, and hence, they are not distinguishable with a significance level of α′. If the condition p<α′ satisfies the two trace partitions, the null hypothesis can be rejected. After C independent tests for the significance level of α′ in each partition, the final probability to reject the null hypothesis becomes the product of individual probabilities (1−α′)^{C}. Note that a confidence level of α=0.05 should be maintained for entire trace width of T(v₁ⁱ,Sₖ) and T(v₂ⁱ,Sₖ). Therefore, confidence α′ for each partition can be calculated with Bonferroni correction as in Equation 3.

This results in a partition-wise significance level of

$${α}^{′} = \frac{0.05}{C} .$$

Family-wise rejection can be executed if any partition of traces has

$$p < \frac{0.05}{C}$$

and the considered stage of the implementation can be classified as “Failed.”

The use of statistical methods comes with the risk of the misclassification of results. Two misclassifications and how the TVLA technique herein handles them are as follows:
Type 1 error (False positives): To reduce Type 1 error, a lower significance level (α) and improved statistical resolution are preferred. “Partitioned DPA” analysis is performed to increase the statistical resolution to include timing-related data, and then Bonferroni correction is performed to reduce the significance level.
Type 2 error (False negatives): To reduce Type 2 error, more sample data should be captured and multiple experiments conducted. Compared to TVLA for symmetric cryptography, the chances of type 2 errors are much less in asymmetric cryptography due to two reasons. 1) Large trace sample size: As illustrated in FIG. 4, stages related to asymmetric key operations are in the order of 10000 (Montgomery multiplication takes 34563 cycles for 192-bit key) while symmetric key operations are in the order of 100 (tinyAES takes 21 cycles for 256-bit key). 2) Large number of experiments: Multiple input combinations in Algorithm 4 increase the number of experiments. The nonce pair is combined with different public keys and random messages to increase the number of different scenarios in the experiments. This reduces the Type 2 error.

### F. Optimal Partitioning of Traces

The objective of partitioning is to have a good statistical resolution over the long trace data collected from different stages. If there are too few partitions, it will lead to more Type 1 errors while too many partitions will cause more Type 2 errors. Since these longer trace data is over bit serialized algorithms, the partition size is dynamically adjusted based on the inputs to the algorithm. This preserves the statistical power of the experiment and provides a more accurate DPA analysis.

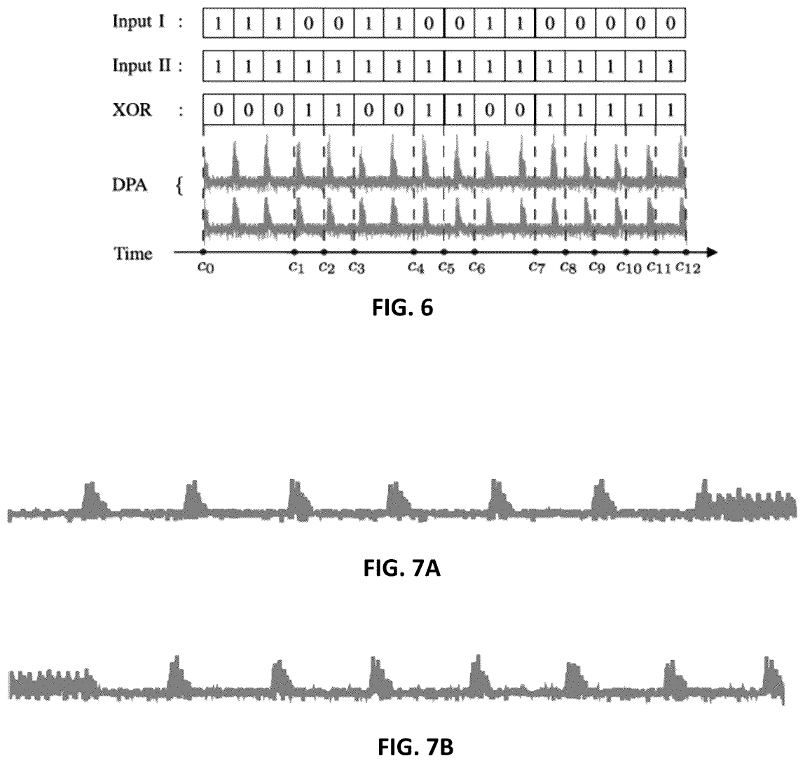

Algorithm 5 presents the steps involved in the dynamic partitioning process. First, an XOR operation is performed on the input values. The XOR result is partitioned such that all consecutive zeros become one partition while each one is separately partitioned into different partitions. For this purpose, the unit length is calculated to process a single bit by taking the ratio of the trace length to the nonce length. Then each partition point is generated with Algorithm 5. FIG. 6 illustrates an example scenario for calculating partitions dynamically. After the dynamic partitioning, the DPA technique is applied to each partition separately and proceeds with the steps discussed herein.

Complexity Analysis: Let the size of two input distributions used for the differential analysis be M (after scaling to the same length). If partitioning is not employed (traditional TVLA), the time complexity of applying the Welch t-test is O(M) since there are O(M) elements in the two distributions. Partitioning the traces with input XOR operation can be performed in a constant time (O(1)). Let n (1≤n≤key_size) be the number of partitions and mᵢ be the number of elements in each partition such that n×Σᵢ₌₁ⁿmᵢ=M. Therefore, the time complexity of applying Welch t-test on all the partitions is also bounded by O(M) since the total number of elements in the two distributions did not change. The last step of the algorithm (familywise rejection) can be performed in a constant time of O(1). Therefore, the partitioned-DPA herein (TVLA) does not increase the complexity compared to traditional TVLA.

### G. Classification Using Divergence Test

The leakage analysis discussed in the previous section analyzes a pair of traces for only one stage in the algorithm. Next are each stage is classified as side-channel vulnerable or safe. Then a decision is made on the entire implementation. Test vector pairs have been generated herein, which results in X×N trace pairs. The Welch t-test was performed followed by Bonferroni correction for each stage of implementation. Each stage is classified as “Pass” or “Fail.” If a particular stage of the implementation is a “Fail” during DPA, the implementation is classified as “Fail.” The implementation is classified as “Pass” if and only if all the stages of the implementation pass the divergence test.

### H. Fixing the TVLA Failing Implementations

If a design fails the divergence test, the design should be fixed against the side channel leakage. This step will involve different techniques in different instances to prevent information leakage. For different stages, there can be different implementation improvements. For example, a popular mitigation is to use the Montgomery ladder for scalar multiplication over double and add since it severely reduces the information leakage through timing. Other mitigations involve randomizing some value being used in the computation to blind it.

Mitigation techniques against horizontal collisions specifically target the modular multiplication of two field values, which are integers. Since these field values can be represented in word form, multiplication takes the form of a matrix. A representation of the matrix is given below, where a and b are the two field values being multiplied together and the entry number corresponds to its word location.

$$[ \begin{matrix}{a}_{1} {b}_{1} & ⋯ & {a}_{1} {b}_{n} \\ ⋮ & ⋱ & ⋮ \\ {a}_{n} {b}_{1} & ⋯ & {a}_{n} {b}_{n}\end{matrix} ]$$

Operands Blinding: Blind each operand with a random value. After multiplication, the resulting blinded value is equivalent to the result of the non-blinded value. This mitigation reduces the efficiency of the horizontal collision correlation analysis attack, however, it does not remove all sources of the leakage. Blinding is memory efficient since it will not take additional memory, however, an additional operation is added for each value that needs blinding.

Shuffling Rows and Columns: Shuffling leads to different permutations of row and column configurations. However, shuffling the rows and columns does not have any impact on the computed values of the matrix entries. It does add to the computational time that the attacker needs to perform the attack by the cost of searching for a permutation. This search is O(n). Additional memory may be required while swapping values.

Shuffling and Blinding: This mitigation combines ideas from the two previous mitigations together. It achieves this by first blinding one value, shuffling the rows with permutations, blinding the second value, and then shuffling the columns with permutations. This technique does prevent the attack but allows for a zero-value attack to be possible that was previously not.

Global Shuffling: This is a variation of Shuffling and Blinding where the permutations of the rows and columns are done at the same time, instead of sequentially. Therefore, the attacker needs to now search through a permutation of size n² instead of two permutations of size n, which is computationally more expensive. Shuffling both the rows and columns at the same time will take more memory than if done sequentially.

### EXPERIMENTS

### A. Experimental Setup

ECDSA and ECIES in Verilog with the algorithms have been implemented herein, including three different EC MULTIPLY algorithms of Double-and-Add, Binary NAF, and Montgomery. SEC's SHA1 implementation in Verilog was used for hashing operations. tinyAES was used in ECIES for AES encryption and decryption. For the key derivation function in ECIES, the standard ANSI X9.63 was used. For the creation and authentication of tags, HMAC-SHA1 was used, with the SHA1 functionality being provided by SEC's SHA1 module. After testing the implementation with NIST prime field curves, the design was instrumented as described herein. Synopsys Design_Compiler with SAED90nm CMOS technology was used for the synthesis of the design. Synopsys VCS was used for the simulations of the designs and to obtain the signal dumps. For test generation, power signature construction, and leakage assessment, appropriate scripts with Python were created. For Partitioned DPA, the traces were dynamically partitioned based on the input nonce with the algorithm proposed herein.

### B. Leakage Assessment of Asymmetric Key Cryptography Algorithms

ECIES and ECDSA implementations are evaluated herein using existing and TVLA methods described herein. Algorithm 2 was used to generate private keys or nonce (as appropriate). All other steps in TVLA remain the same for the rest of the evaluation. Since direct evaluation is not possible due to input test generation difference, the standard Welch t-test is used to compare results. Table II presents the final evaluation performed on different modes of ECC implementations with the standard Welch t-test and the proposed TVLA methodology. Each column shows the percentage of experiments “failed” the DPA analysis out of 1000 experiments. The results illustrate true positive, true negative, false positive, and false negative results. It can be observed that the Binary NAF algorithm has been subjected to type 1 error due to not having timing-related information on the standard Welch t-test. The tiny_AES implementation was also detected as side-channel vulnerable with TVLA.

### C. Effect of Partitioned T-Test

The effectiveness of partitioned DPA (preserved the timing information of the traces) over standard divergence measuring techniques is evaluated herein. A test case is used that fails the SPA. For this, the EC MULTIPLY algorithm Double-and-Add is used with two nonce values of “0xFF00” and “0x00FF.” As illustrated in FIGS. 7A and 7B, power traces are inverted over the time axis and hence divergence test should fail.

As illustrated in Table III, standard Welch t-test and KL divergence do not take timing information into account and hence provided false positive results. The proposed partition-based differential power analysis herein distinguishes the two traces since the analysis is done on multiple different partitions (16 partitions in this specific example).

### D. Dynamic Partitioning of Trace Data

A separate experiment was conducted to demonstrate the effectiveness of dynamic partitioning. For this purpose, 1000 trace data pairs were generated with the scalar multiplication implementation with the Montgomery algorithm (with shuffling and blinding mitigation). Then modifications were introduced to the Montgomery implementation to have a subtle imbalance in the switching activity over the nonce multiplication and generated a separate data set that consists of 1000 trace data pairs. These two data sets serve as the known labeled data set for the evaluation of the results of the experiment.

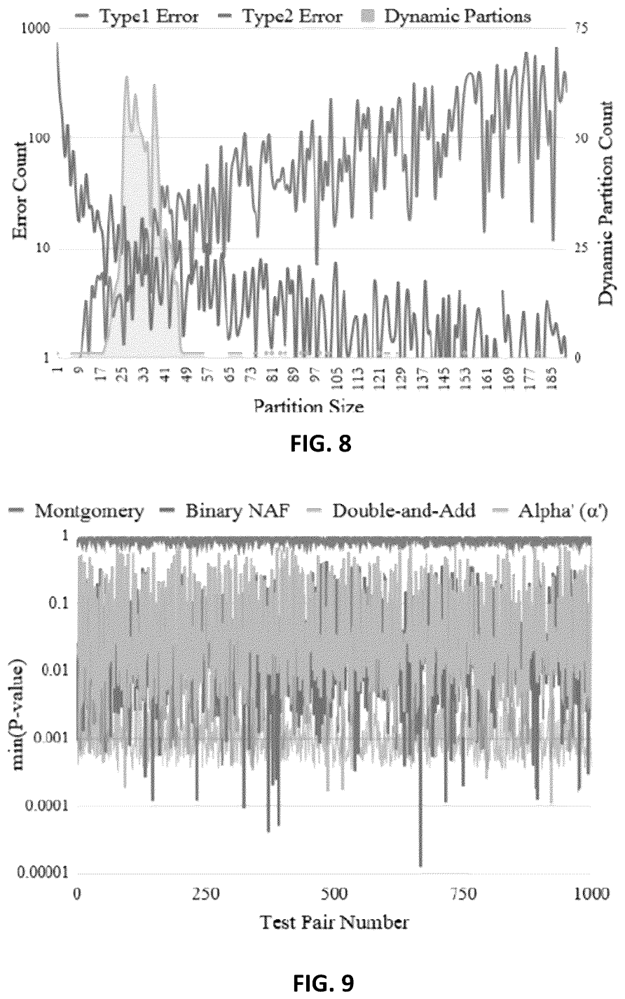

In the next step, experiments were conducted with both data sets with different partition sizes ranging from 1 to nonce size (in this case 192). Next, dynamic partitioning were deployed on both data sets to observe the number of partitions that resulted in the comparisons. FIG. 8 presents the relationship between Type 1 error and Type 2 error with the number of partitions in the trace data. This illustrated that the proposed dynamic partitioning technique selects the best partition for the statistical comparison.

### E. TVLA on Different EC MULTIPLY Algorithms

As discussed above, EC MULTIPLY is the victim for most of the side-channel attacks. Therefore, the three algorithms were evaluated that were implemented in Verilog. Binary NAF and Double-and-Add should fail the experiment since these algorithms contain imbalanced finite-state machine (FSM) operations that depend on inputs. For the Montgomery algorithm, multiple variations have been implemented with and without mitigation techniques and TVLA was applied. Table IV presents the results of the experiment with minimum observed p-value in each experiment with different mitigation techniques. Brown-colored cells indicate rejected implementations from the divergence test while green-colored cells represent implementations that are classified as safe against side channel leakage by TVLA framework.

FIG. 9 presents the minimum p-value (y axis in log scale) observed among each partition against the generated test vectors with three algorithms of Montgomery (with blinding and shuffling), Binary NAF, and Double-and-Add. Here α′ represented the minimum p-value to accept the null hypothesis, which is calculated with dynamic partitioning (

$${α}^{′} = \frac{0.05}{C}$$

where C is the number of partitions). As expected, it can be observed that for Binary NAF and Double-and-Add, TVLA has rejected the null hypothesis with the confidence of 99.999% (with p<α).

### F. Physical Leakage Locations in ECDSA and ECIES

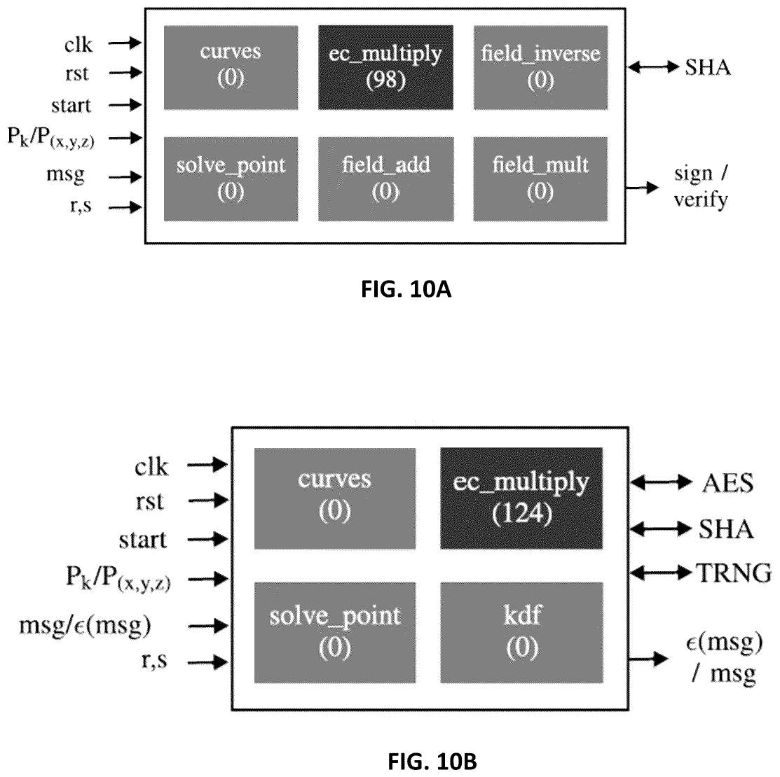

The TVLA framework presented herein analyzes the power usage of a cryptographic implementation at the presilicon stage. It divides implementation into stages by analyzing the control flags. Therefore, the evaluation (detection) results provide the information about all the stages. A designer is mostly interested in the stages (components) that failed TVLA analysis, which would be a potential leakage location in the fabricated chip. FIG. 10A shows the leakage locations in the ECDSA implementation. In this evaluation, ec_multiply module failed for 98 partitioned-DPA tests. None of the other ECDSA submodules failed during the evaluation consisting of 3000 tests.

FIG. 10B shows the leakage locations in the ECIES implementation. As shown in FIGS. 10A and 10B, ec_multiply module failed for 124 partitioned-DPA tests. None of the other ECIES modules failed during the evaluation consisting of 3000 tests. It can be observed from FIGS. 10A and 10B that the scalar multiplication module (ec_multiply) is the most leaky location in both ECIES and ECDSA implementations.

### G. Testing TVLA on Bare Metal ECC Implementation

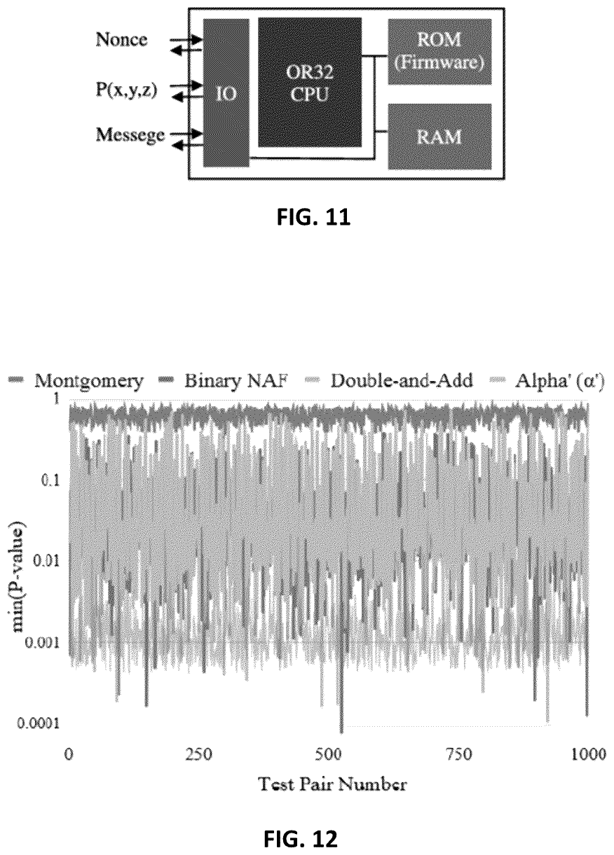

In this experiment, the possibility of using the proposed TVLA technique is highlighted on firmware-level implementations of public key cryptography modules on embedded systems. For this process, the OpenRiscV32 processor was used, implemented in Verilog as the host processor for the embedded system. Next, ECC cryptography modules were implemented in C and compiled with the RISC-V toolchain. FIG. 11 illustrates the module level block diagram of the hardware setup. Then different scalar multiplication algorithms were evaluated against their side-channel leakage.

FIG. 12 illustrates the minimum p-values observed on firmware level implementation of scalar multiplication algorithms of Montgomery (with shuffling and blinding), Binary NAF and Double-and-Add. Here α′ represents the minimum p-value to accept the null hypothesis, which is calculated with dynamic partitioning (

$${α}^{′} = \frac{0.05}{C}$$

where C is the number of partitions). As expected, it can be observed that for firmware implementations of Binary NAF and Double-and-Add, TVLA has rejected the null hypothesis with the confidence of 99.999% (with p<α).

Embodiments herein provide for a test vector leakage assessment (TVLA) technique for asymmetric key cryptography algorithms. Embodiments herein evaluate the applicability of existing TVLA techniques on asymmetric algorithms and identified the fundamental limitations. A systematic test generation technique is described herein to generate valid test cases that can maximize the switching difference in side-channel vulnerable implementations. Embodiments herein provide for a differential power analysis technique for asymmetric key cryptography algorithms. Specifically, a partition-based t-test evaluation technique is presented herein to evaluate with higher statistical accuracy while preserving timing information over the traces. Experimental evaluation on diverse elliptic curve cryptography algorithms demonstrated that techniques herein have better accuracy than statistical techniques used in TVLA for symmetric key cryptography algorithms.

### H. Applicability

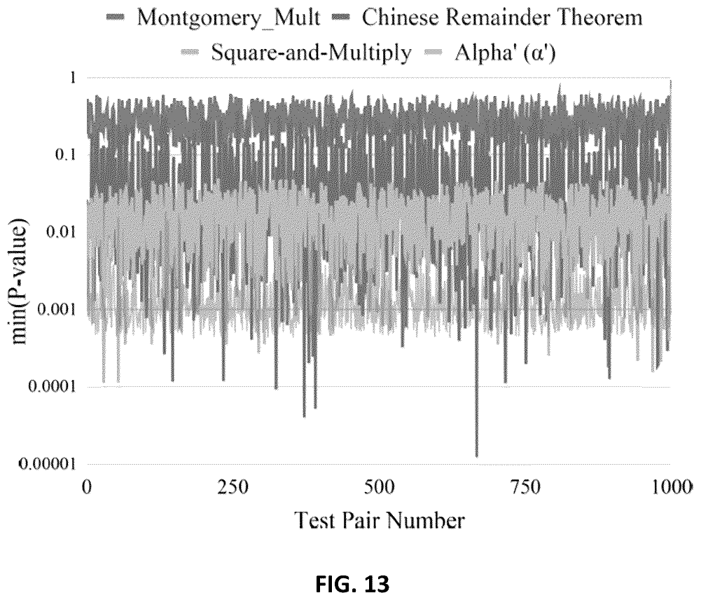

It will be appreciated that embodiments discussed herein have been in relation to ECC family of algorithms due to their improved security and performance. Furthermore, the implementation of ECC-based hardware algorithms can be considered more complex compared to the other asymmetric-key cryptography algorithms. However, the applicability of the present TVLA innovations are not limited to asymmetric cryptosystems based on the ECC family. In order to demonstrate the applicability of TVLA on other asymmetric cryptography algorithms, three RSA implementations based on three different algorithms are discussed: Chinese remainder theorem (CRT), Montgomery multiplication, and square-and-multiply method. Then, three designs of RSA are evaluated that implement the above algorithms with TVLA. Finally, the applicability of TVLA on hybrid cryptosystems is discussed.
1) RSA With CRT: CRT optimization is applied during the decryption process to speed up the modular exponentiation. Instead of performing a single modular exponentiation operation using the private exponent, the CRT method breaks it down into multiple smaller modular exponentiations using the prime factors of the modulus. This smaller modular exponentiation can be computed separately and combined using the CRT formulas. However, the CRT method can introduce vulnerabilities to power side-channel attacks. For example, the power consumption during the modular exponentiation steps might vary depending on the value of the corresponding prime factor. An attacker can exploit these variations to extract information about the secret key.
2) RSA With Square-and-Multiply: In the square-and-multiply algorithm, the exponent is typically represented in binary form, and the algorithm performs repeated squaring and multiplications based on the bits of the exponent. These operations can result in different power consumption patterns depending on the value of each bit.
3) RSA With Montgomery Multiplication: In the case of Montgomery multiplication, the power consumption patterns can vary depending on the intermediate values and operations performed during the algorithm. For example, the number of shifts and additions involved in Montgomery multiplication can introduce variations in power consumption. An attacker can analyze these power consumption patterns to potentially deduce information about the secret key or other sensitive data.
4) TVLA on RSA: Three different Verilog implementations of RSA with three different algorithms have been used (CRT, square-and-multiply, and Montgomery multiplication with shuffling and blinding mitigation). FIG. 13 shows the minimum p-values observed after performing the present TVLA methodology. As expected, power side-channel vulnerability of mitigated RSA implementation based on the Montgomery multiplication algorithm is classified by the present TVLA as safe against side-channel leakage, while implementations based on the CRT and square-and-multiply are classified as susceptible to power side-channel leakage.
5) TVLA on Hybrid Cryptosystems: The present TVLA innovations enable the evaluation of hybrid cryptosystems, which combines both asymmetric and symmetric components in the implementation. Since the components are evaluated separately, asymmetric components of the system can be evaluated with TVLA according to embodiments herein, while symmetric components can be evaluated with other symmetric TVLA techniques. The composition of results is trivial since it is considered a system failure if any of the components fail.

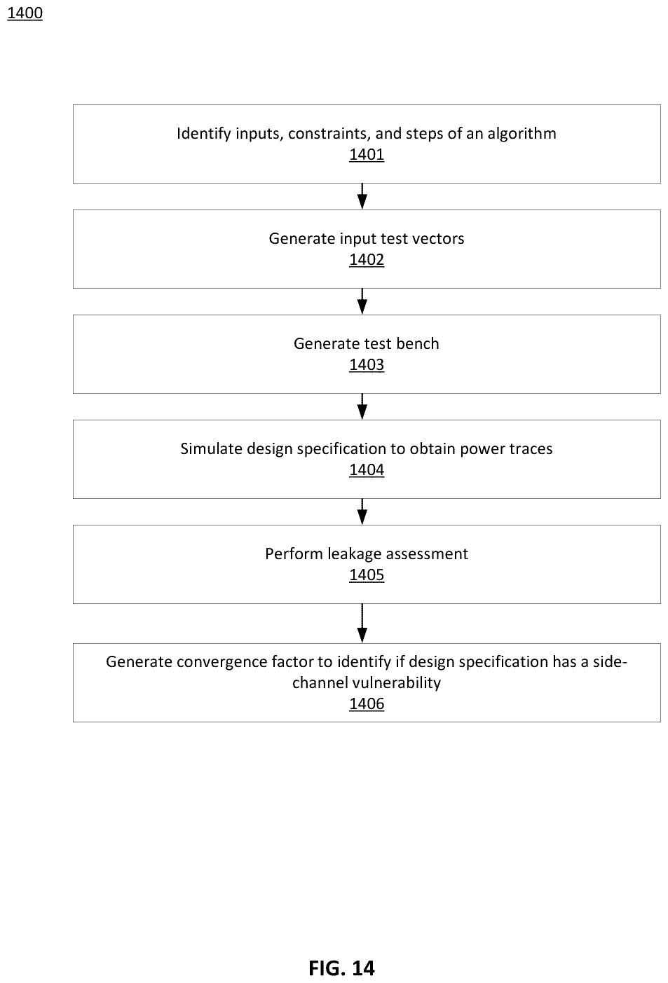

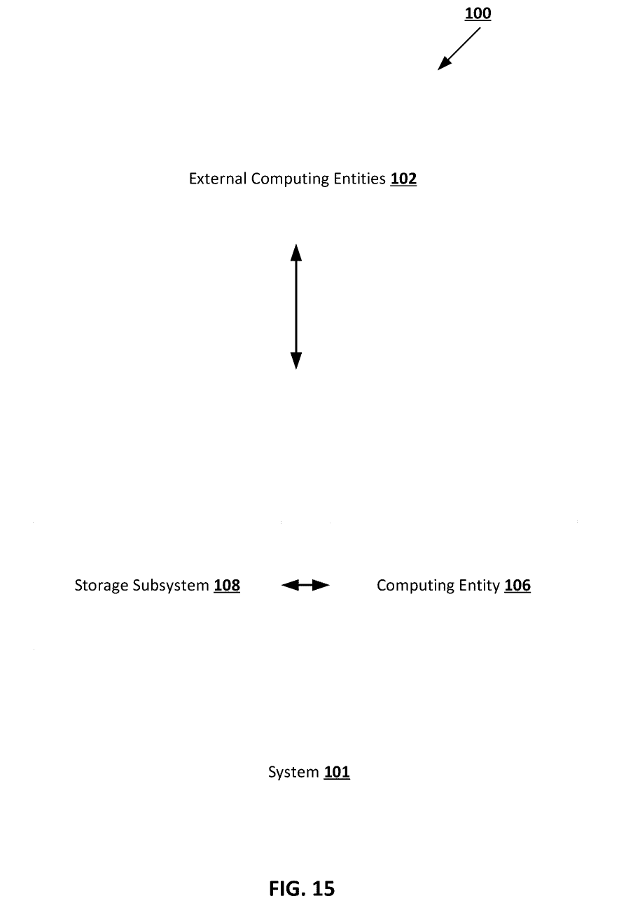

FIG. 14 depicts example operations in accordance with embodiments herein. Operations depicted in FIG. 14 and discussed herein may be implemented using one or more apparatuses or systems described with respect to FIGS. 15, 16, and 17.

Shown in FIG. 14, an example method 1400 for side-channel leakage evaluation of asymmetric key cryptography algorithms includes identifying 1401 inputs, constraints, and a sequence of steps involved in an algorithm of a design specification. The method 1400 further includes generating 1402 input test vectors. The input test vectors are associated with a secrecy guarantee of the algorithm. The method 1400 further includes generating 1402 a testbench for simulation of the design specification. The method 1400 further includes generating 1403 power traces by simulating the design specification. The method 1400 further includes performing 1404 a leakage assessment on generated power profiles using one or more of simple power analysis or differential power analysis. The method 1400 further includes generating 1405, based at least in part on the power traces and leakage assessment, a divergence factor. The method 1400 further includes determining 1406, and based at least in part on the divergence factor, whether the design specification has a side-channel vulnerability.

In some embodiments, the method may include, responsive to determining that the design specification has a side-channel vulnerability, modifying the design specification to eliminate side-channel leakage. In some embodiments, modifying the design specification comprises mitigation for scalar multiplication. In some embodiments, modifying the design specification comprises Montgomery ladder-based implementation.

In some embodiments, the method may include dynamically partitioning trace data. Dynamically partitioning the trace data improves statistical resolution to reduce type 1 errors and type 2 errors. The type 1 errors comprise false positives and the type 2 errors comprise false negatives.

In some embodiments, the algorithm comprises an asymmetric key cryptography algorithm and the method may also include automatically generating directed tests to maximize side-channel sensitivity of the asymmetric key cryptographic algorithm.

In some embodiments, the algorithm comprises an asymmetric key cryptography algorithm and the method may also include automatically identifying each stage in the asymmetric key cryptographic algorithm, and evaluating a side-channel leakage of each stage.

In some embodiments, the method may include evaluating side-channel leakage of a hybrid cryptosystem comprising symmetric key cryptography algorithms and asymmetric key cryptography algorithms.

In some embodiments, the algorithm comprises an asymmetric key cryptography algorithm and the design specification is associated with one of a hardware implementation or firmware implementation of the asymmetric key cryptography algorithm.

TABLE I
Inputs for different ECC algorithms

| | Inputs | | | | |
|---|---|---|---|---|---|
| Algorithm | Nonce | Private Key | P(x, y, z) | Msg | Tag |
| ECIES encrypt | X | | X | X | |
| ECIES decrypt | | X | | | X |
| ECDSA sign | X | X | | X | |
| ECDSA verify | | | X | X | |

TABLE II
Evaluation on ECC Verilog implementations with Welch t-test and partitioned Welch t-test in TVLA

| | Welch t-test in TVLA | | | | | | Partitioned Welch t-test in TVLA | | | | | |
|---|---|---|---|---|---|---|---|---|---|---|---|---|
| Implemen- | EC MULTIPLY | | | CORD. | | Tiny | EC MULTIPLY | | | CORD. | | Tiny |
| tation | D. Add | B. NAF | Mont | CONV | SHA1 | AES | D. Add | B. NAF | Mont | CONV | SHA1 | AES |
| ECIES | 4.6% | 0% | 0% | 0% | 0% | 0.012% | 18.9% | 19.2% | 0% | 0% | 0% | 0.012% |
| encryption | | | | | | | | | | | | |
| ECIES | 6.2% | 0% | 0% | 0% | 0% | 0.008% | 17.6% | 21.1% | 0% | 0% | 0% | 0.008% |
| decryption | | | | | | | | | | | | |
| ECDSA | 5.9% | 0% | 0% | 0% | 0% | | 20.9% | 18.3% | 0% | 0% | 0% | |
| sign | | | | | | | | | | | | |
| ECDSA | 4.2% | 0% | 0% | 0% | 0% | | 16.7% | 16.9% | 0% | 0% | 0% | |
| verify | | | | | | | | | | | | |

TABLE III
Divergence test on traces of 0xFF00 and 0x00FF

| Method | Welch t-test | KL divergence | TVLA |
|---|---|---|---|
| Result | False Positive | False Positive | True Negative |

TABLE IV
Minimum p-values observed with Montgomery
multiplication algorithm

| | Without | | | Shuffling | Global |
|---|---|---|---|---|---|
| # | Mitigation | Blinding | Shuffling | and Blinding | Shuffling |
| 1 | 0.0042 | 0.0258 | 0.1842 | 0.4947 | 0.6854 |
| 2 | 0.0059 | 0.0009 | 0.2874 | 0.7398 | 0.7458 |
| 3 | 0.0048 | 0.0085 | 0.1879 | 0.5009 | 0.5748 |
| 4 | 0.0106 | 0.0147 | 0.2935 | 0.8456 | 0.6875 |

TABLE V
Divergence test on different EC Multiply Algorithms

| | |
|---|---|
| EC MULTIPLY | TVLA |

| | # Clk | | | Divergence |
|---|---|---|---|---|
| Algorithm | Cycles | SPA | Min(p) | Test |
| Double-and- | 20606 | Fail | 0.00010 | Fail |
| Add | | | | |
| Binary NAF | 3837 | Pass | 0.00006 | Fail |
| Montgomery | 34563 | Pass | 0.61739 | Pass |

Algorithm 1 Coordinate Conversion

```
Require: P : (X₁, Y₁, Z₁), P ≠ O
Ensure: R : (X₂, Y₂)
  1: λ ← Z₁⁻¹ mod p
  2: X₂ ← λ²X₁
  3: Y₂ ← λ³Y₁
```

Algorithm 2 Scalar Multiplication-Double and Add

```
Require: P : (X, Y), P ≠ O, k positive integer
Ensure: kP
  R₀ ← O
  R₁ ← P
  for bit in k do
    if bit = 1 then
      R₀ ← R₀ + R₁
    end if
    R₁ ← 2R₁
end for
return R₀
```

Algorithm 3 Generation of Nonce Pairs

```
Require: NonceSize d, NumPairs N
Ensure: NoncePairs {{n₁¹, n₁²}..{n_{N}¹, n_{N}²}}
  1: tests = [{zeroBin(d), oneBin(d)}]
  2: for x ∈ [2ⁱ for i = log₂ d; i > 0; i− −] do
  3: n2 ← ∅
  4: while len(n2) < d do
  5: n2 ← n2 + zeroBin(x) + oneBin(x)
  6: end while
  7: tests.append({oneBin(d), n2[0 : d]})
  8: end for
  9: for y ∈ (N − len(tests)) do
10: tests.append({oneBin(d), randBin(d)})
11: end for
12: Return tests
```

Algorithm 4 Generation of Test Vector Pairs

```
Require: PubKeys {p₁, .., pₓ}, NoncePairs {{n₁¹, n₁²}..{n_{y}¹, n_{y}²}}
Ensure: TestVectorPairs {{t₁¹, t₁²}, .., {t_{N}¹, t_{N}²}}
  1: vectors = [ ]
  2: for x ∈ {p₁, .., pₓ} do
  3: pK ← x
  4: msg ← randBin(len(msg))
  5: for {y₁, y₂} ∈ {{n₁¹, n₁²}, .., {n_{y}¹, n_{y}²}} do
  6: t1 ← {pk, msg, y₁}
  7: t2 ← {pk, msg, y₂}
  8: vectors.append({t1,t2})
  9: end for
10: end for
11: Return vectors
```

Algorithm 5 Trace Partitioning

```
Require: TestPair {tᵢ¹, tᵢ²}
Ensure: Partitions {c₁, c₂, ... , cₙ}
  1: t_{XOR} = tᵢ¹ ⊕ tᵢ²
  $2 : C = \{ \} , prev = 1 , U = \frac{TraceLength}{NonceLength}$
  3: for bit ∈ t_{XOR} do
  4:  if bit = 1 then
  5:  if prev = 0 then
  6:  C.append(ptr)
  7:  end if
  8:  prev = 1
  9:  ptr = ptr + U
10:  C.append(ptr)
11:  else
12:  prev = 0
13:  ptr = ptr + U
14:  end if
15: end for
16: Return C
```

### Computer Program Products, Methods, and Computing Entities

Embodiments of the present disclosure may be implemented in various ways, including as computer program products that comprise articles of manufacture. Such computer program products may include one or more software components including, for example, software objects, methods, data structures, or the like. A software component may be coded in any of a variety of programming languages. An illustrative programming language may be a lower-level programming language such as an assembly language associated with a particular hardware framework and/or operating system platform. A software component comprising assembly language instructions may require conversion into executable machine code by an assembler prior to execution by the hardware framework and/or platform. Another example programming language may be a higher-level programming language that may be portable across multiple frameworks. A software component comprising higher-level programming language instructions may require conversion to an intermediate representation by an interpreter or a compiler prior to execution.

Other examples of programming languages include, but are not limited to, a macro language, a shell or command language, a job control language, a script language, a database query, or search language, and/or a report writing language. In one or more example embodiments, a software component comprising instructions in one of the foregoing examples of programming languages may be executed directly by an operating system or other software component without having to be first transformed into another form. A software component may be stored as a file or other data storage construct. Software components of a similar type or functionally related may be stored together such as in a particular directory, folder, or library. Software components may be static (e.g., pre-established or fixed) or dynamic (e.g., created or modified at the time of execution).

A computer program product may include non-transitory computer-readable storage medium storing applications, programs, program modules, scripts, source code, program code, object code, byte code, compiled code, interpreted code, machine code, executable instructions, and/or the like (also referred to herein as executable instructions, instructions for execution, computer program products, program code, and/or similar terms used herein interchangeably). Such non-transitory computer-readable storage media include all computer-readable media (including volatile and non-volatile media).

In one embodiment, a non-volatile computer-readable storage medium may include a floppy disk, flexible disk, hard disk, solid-state storage (SSS) (e.g., a solid-state drive (SSD)), solid state card (SSC), solid state module (SSM), enterprise flash drive, magnetic tape, or any other non-transitory magnetic medium, and/or the like. A non-volatile computer-readable storage medium may also include a punch card, paper tape, optical mark sheet (or any other physical medium with patterns of holes or other optically recognizable indicia), compact disc read only memory (CD-ROM), compact disc-rewritable (CD-RW), digital versatile disc (DVD), Blu-ray disc (BD), any other non-transitory optical medium, and/or the like. Such a non-volatile computer-readable storage medium may also include read-only memory (ROM), programmable read-only memory (PROM), erasable programmable read-only memory (EPROM), electrically erasable programmable read-only memory (EEPROM), flash memory (e.g., Serial, NAND, NOR, and/or the like), multimedia memory cards (MMC), secure digital (SD) memory cards, SmartMedia cards, CompactFlash (CF) cards, Memory Sticks, and/or the like. Further, a non-volatile computer-readable storage medium may also include conductive-bridging random access memory (CBRAM), phase-change random access memory (PRAM), ferroelectric random-access memory (FeRAM), non-volatile random-access memory (NVRAM), magnetoresistive random-access memory (MRAM), resistive random-access memory (RRAM), Silicon-Oxide-Nitride-Oxide-Silicon memory (SONOS), floating junction gate random access memory (FJG RAM), Millipede memory, racetrack memory, and/or the like.

In one embodiment, a volatile computer-readable storage medium may include random access memory (RAM), dynamic random access memory (DRAM), static random access memory (SRAM), fast page mode dynamic random access memory (FPM DRAM), extended data-out dynamic random access memory (EDO DRAM), synchronous dynamic random access memory (SDRAM), double data rate synchronous dynamic random access memory (DDR SDRAM), double data rate type two synchronous dynamic random access memory (DDR2 SDRAM), double data rate type three synchronous dynamic random access memory (DDR3 SDRAM), Rambus dynamic random access memory (RDRAM), Twin Transistor RAM (TTRAM), Thyristor RAM (T-RAM), Zero-capacitor (Z-RAM), Rambus in-line memory module (RIMM), dual in-line memory module (DIMM), single in-line memory module (SIMM), video random access memory (VRAM), cache memory (including various levels), flash memory, register memory, and/or the like. It will be appreciated that where embodiments are described to use a computer-readable storage medium, other types of computer-readable storage media may be substituted for or used in addition to the computer-readable storage media described above.

As should be appreciated, various embodiments of the present disclosure may also be implemented as methods, apparatuses, systems, computing devices, computing entities, and/or the like. As such, embodiments of the present disclosure may take the form of an apparatus, system, computing device, computing entity, and/or the like executing instructions stored on a computer-readable storage medium to perform certain steps or operations. Thus, embodiments of the present disclosure may also take the form of an entirely hardware embodiment, an entirely computer program product embodiment, and/or an embodiment that comprises combination of computer program products and hardware performing certain steps or operations.

Embodiments of the present disclosure are described below with reference to block diagrams and flowchart illustrations. Thus, it should be understood that each block of the block diagrams and flowchart illustrations may be implemented in the form of a computer program product, an entirely hardware embodiment, a combination of hardware and computer program products, and/or apparatuses, systems, computing devices, computing entities, and/or the like carrying out instructions, operations, steps, and similar words used interchangeably (e.g., the executable instructions, instructions for execution, program code, and/or the like) on a computer-readable storage medium for execution. For example, retrieval, loading, and execution of code may be performed sequentially such that one instruction is retrieved, loaded, and executed at a time. In some example embodiments, retrieval, loading, and/or execution may be performed in parallel such that multiple instructions are retrieved, loaded, and/or executed together. Thus, such embodiments can produce specifically configured machines performing the steps or operations specified in the block diagrams and flowchart illustrations. Accordingly, the block diagrams and flowchart illustrations support various combinations of embodiments for performing the specified instructions, operations, or steps.

### Example System Framework

FIG. 15 provides an example overview of a system 100 that can be used to practice embodiments of the present disclosure. The system 100 includes a system 101 comprising a computing entity 106. The system 101 may communicate with one or more external computing entities 102A-N using one or more communication networks. Examples of communication networks include any wired or wireless communication network including, for example, a wired or wireless local area network (LAN), personal area network (PAN), metropolitan area network (MAN), wide area network (WAN), or the like, as well as any hardware, software and/or firmware required to implement it (e.g., network routers, and/or the like).

The system 100 includes a storage subsystem 108 configured to store at least a portion of the data utilized by the system 101. The computing entity 106 may be in communication with the external computing entities 102A-N.

The storage subsystem 108 may be configured to store the model definition data store and the training data store for one or more machine learning models. The computing entity 106 may be configured to receive requests and/or data from at least one of the external computing entities 102A-N, process the requests and/or data to generate outputs, and provide the outputs to at least one of the external computing entities 102A-N. In some embodiments, the external computing entity 102A, for example, may periodically update/provide raw and/or processed input data to the system 101. The external computing entities 102A-N may further generate user interface data (e.g., one or more data objects) corresponding to the outputs and may provide (e.g., transmit, send, and/or the like) the user interface data corresponding with the outputs for presentation to the external computing entity 102A (e.g., to an end-user).

The storage subsystem 108 may be configured to store at least a portion of the data utilized by the computing entity 106 to perform one or more steps/operations and/or tasks described herein. The storage subsystem 108 may be configured to store at least a portion of operational data and/or operational configuration data including operational instructions and parameters utilized by the computing entity 106 to perform the one or more steps/operations described herein. The storage subsystem 108 may include one or more storage units, such as multiple distributed storage units that are connected through a computer network. Each storage unit in the storage subsystem 108 may store at least one of one or more data assets and/or one or more data about the computed properties of one or more data assets. Moreover, each storage unit in the storage subsystem 108 may include one or more non-volatile storage or memory media including but not limited to hard disks, ROM, PROM, EPROM, EEPROM, flash memory, MMCs, SD memory cards, Memory Sticks, CBRAM, PRAM, FeRAM, NVRAM, MRAM, RRAM, SONOS, FJG RAM, Millipede memory, racetrack memory, and/or the like.

The computing entity 106 can include an analysis engine and/or a training engine. The analysis engine may be configured to perform one or more data analysis techniques. The training engine may be configured to train the analysis engine in accordance with the data store stored in the storage subsystem 108.

### Example Computing Entity

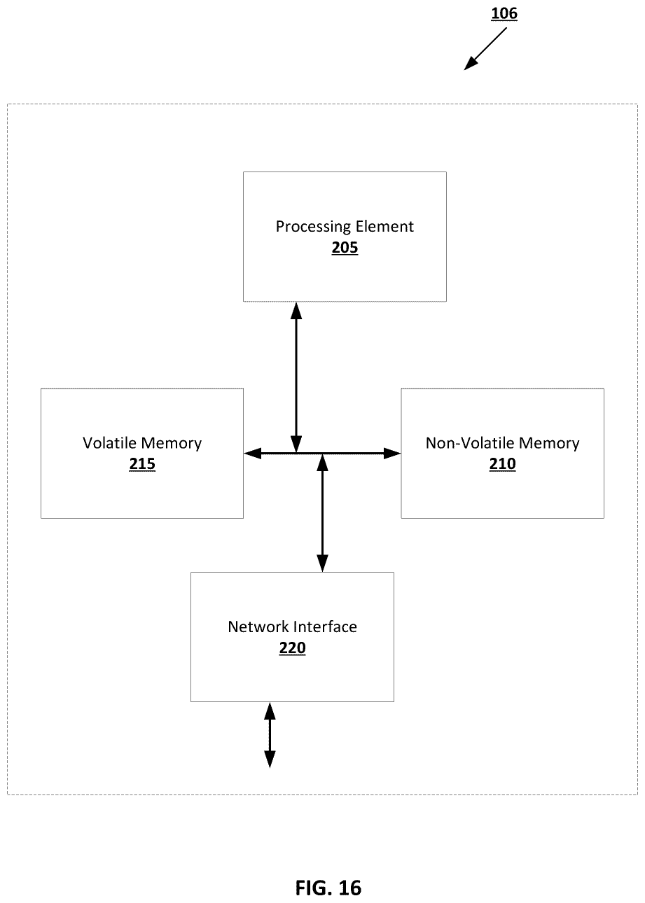

FIG. 16 provides an example computing entity 106 in accordance with some embodiments discussed herein. In general, the terms computing entity, computer, entity, device, system, and/or similar words used herein interchangeably may refer to, for example, one or more computers, computing entities, desktops, mobile phones, tablets, notebooks, laptops, distributed systems, kiosks, input terminals, servers or server networks, blades, gateways, switches, processing devices, processing entities, set-top boxes, relays, routers, network access points, base stations, the like, and/or any combination of devices or entities adapted to perform the functions, steps/operations, and/or processes described herein. Such functions, steps/operations, and/or processes may include, for example, transmitting, receiving, operating on, processing, displaying, storing, determining, creating/generating, monitoring, evaluating, comparing, and/or similar terms used herein interchangeably. In one embodiment, these functions, steps/operations, and/or processes can be performed on data, content, information, and/or similar terms used herein interchangeably.

The computing entity 106 may include a network interface 220 for communicating with various computing entities, such as by communicating data, content, information, and/or similar terms used herein interchangeably that can be transmitted, received, operated on, processed, displayed, stored, and/or the like.

In one embodiment, the computing entity 106 may include or be in communication with a processing element 205 (also referred to as processors, processing circuitry, and/or similar terms used herein interchangeably) that communicate with other elements within the computing entity 106 via a bus, for example. As will be understood, the processing element 205 may be embodied in a number of different ways including, for example, as at least one processor/processing apparatus, one or more processors/processing apparatuses, and/or the like.

For example, the processing element 205 may be embodied as one or more complex programmable logic devices (CPLDs), microprocessors, multi-core processors, coprocessing entities, application-specific instruction-set processors (ASIPs), microcontrollers, and/or controllers. Further, the processing element 205 may be embodied as one or more other processing devices or circuitry. The term circuitry may refer to an entirely hardware embodiment or a combination of hardware and computer program products. Thus, the processing element 205 may be embodied as integrated circuits, application specific integrated circuits (ASICs), field programmable gate arrays (FPGAs), programmable logic arrays (PLAs), hardware accelerators, other circuitry, and/or the like.

As will therefore be understood, the processing element 205 may be configured for a particular use or configured to execute instructions stored in one or more memory elements including, for example, one or more volatile memories 215 and/or non-volatile memories 210. As such, whether configured by hardware or computer program products, or by a combination thereof, the processing element 205 may be capable of performing steps or operations according to embodiments of the present disclosure when configured accordingly. The processing element 205, for example in combination with the one or more volatile memories 215 and/or or non-volatile memories 210, may be capable of implementing one or more computer-implemented methods described herein. In some implementations, the computing entity 106 can include a computing apparatus, the processing element 205 can include at least one processor of the computing apparatus, and the one or more volatile memories 215 and/or non-volatile memories 210 can include at least one memory including program code. The at least one memory and the program code can be configured to, upon execution by the at least one processor, cause the computing apparatus to perform one or more steps/operations described herein.

The non-volatile memories 210 (also referred to as non-volatile storage, memory, memory storage, memory circuitry, media, and/or similar terms used herein interchangeably) may include at least one non-volatile memory device 210, including but not limited to hard disks, ROM, PROM, EPROM, EEPROM, flash memory, MMCs, SD memory cards, Memory Sticks, CBRAM, PRAM, FeRAM, NVRAM, MRAM, RRAM, SONOS, FJG RAM, Millipede memory, racetrack memory, and/or the like.

As will be recognized, the non-volatile memories 210 may store databases, database instances, database management systems, data, applications, programs, program modules, scripts, source code, object code, byte code, compiled code, interpreted code, machine code, executable instructions, and/or the like. The term database, database instance, database management system, and/or similar terms used herein interchangeably may refer to a collection of records or data that is stored in a computer-readable storage medium using one or more database models, such as a hierarchical database model, network model, relational model, entity-relationship model, object model, document model, semantic model, graph model, and/or the like.

The one or more volatile memories 215 (also referred to as volatile storage, memory, memory storage, memory circuitry, media, and/or similar terms used herein interchangeably) can include at least one volatile memory device, including but not limited to RAM, DRAM, SRAM, FPM DRAM, EDO DRAM, SDRAM, DDR SDRAM, DDR2 SDRAM, DDR3 SDRAM, RDRAM, TTRAM, T-RAM, Z-RAM, RIMM, DIMM, SIMM, VRAM, cache memory, register memory, and/or the like.

As will be recognized, the volatile memories 215 may be used to store at least portions of the databases, database instances, database management systems, data, applications, programs, program modules, scripts, source code, object code, byte code, compiled code, interpreted code, machine code, executable instructions, and/or the like being executed by, for example, the processing element 205. Thus, the databases, database instances, database management systems, data, applications, programs, program modules, scripts, source code, object code, byte code, compiled code, interpreted code, machine code, executable instructions, and/or the like may be used to control certain embodiments of the operation of the computing entity 106 with the assistance of the processing element 205.

As indicated, in one embodiment, the computing entity 106 may also include the network interface 220 for communicating with various computing entities, such as by communicating data, content, information, and/or the like that can be transmitted, received, operated on, processed, displayed, stored, and/or the like. Such communication data may be executed using a wired data transmission protocol, such as fiber distributed data interface (FDDI), digital subscriber line (DSL), Ethernet, asynchronous transfer mode (ATM), frame relay, data over cable service interface specification (DOCSIS), or any other wired transmission protocol. Similarly, the computing entity 106 may be configured to communicate via wireless client communication networks using any of a variety of protocols, such as general packet radio service (GPRS), Universal Mobile Telecommunications System (UMTS), Code Division Multiple Access 2000 (CDMA2000), CDMA2000 1X (1xRTT), Wideband Code Division Multiple Access (WCDMA), Global System for Mobile Communications (GSM), Enhanced Data rates for GSM Evolution (EDGE), Time Division-Synchronous Code Division Multiple Access (TD-SCDMA), Long Term Evolution (LTE), Evolved Universal Terrestrial Radio Access Network (E-UTRAN), Evolution-Data Optimized (EVDO), High Speed Packet Access (HSPA), High-Speed Downlink Packet Access (HSDPA), IEEE 802.11 (Wi-Fi), Wi-Fi Direct, 802.16 (WiMAX), ultra-wideband (UWB), infrared (IR) protocols, near field communication (NFC) protocols, Wibree, Bluetooth protocols, wireless universal serial bus (USB) protocols, and/or any other wireless protocol.

### Example External Computing Entity

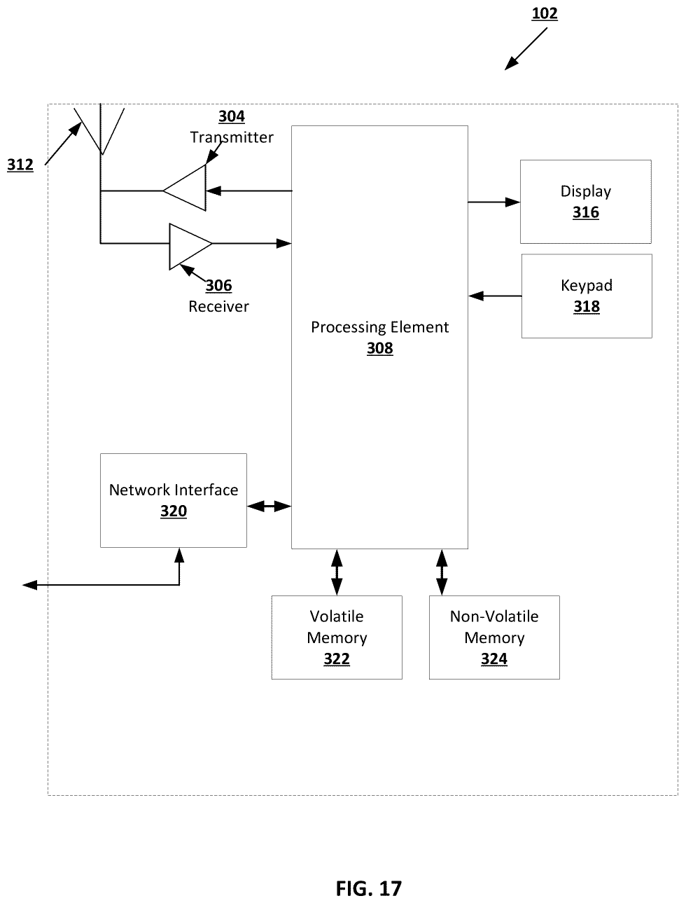

FIG. 17 provides an example external computing entity 102A in accordance with some embodiments discussed herein. In general, the terms device, system, computing entity, entity, and/or similar words used herein interchangeably may refer to, for example, one or more computers, computing entities, desktops, mobile phones, tablets, phablets, notebooks, laptops, distributed systems, kiosks, input terminals, servers or server networks, blades, gateways, switches, processing devices, processing entities, set-top boxes, relays, routers, network access points, base stations, the like, and/or any combination of devices or entities adapted to perform the functions, steps/operations, and/or processes described herein. The external computing entities 102A-N can be operated by various parties. As shown in FIG. 3, the external computing entity 102A can include an antenna 312, a transmitter 304 (e.g., radio), a receiver 306 (e.g., radio), and/or an external entity processing element 308 (e.g., CPLDs, microprocessors, multi-core processors, coprocessing entities, ASIPs, microcontrollers, and/or controllers) that provides signals to and receives signals from the transmitter 304 and the receiver 306, correspondingly. As will be understood, the external entity processing element 308 may be embodied in a number of different ways including, for example, as at least one processor/processing apparatus, one or more processors/processing apparatuses, and/or the like as described herein with reference to the processing element 205.

The signals provided to and received from the transmitter 304 and the receiver 306, correspondingly, may include signaling information/data in accordance with air interface standards of applicable wireless systems. In this regard, the external computing entity 102A may be capable of operating with one or more air interface standards, communication protocols, modulation types, and access types. More particularly, the external computing entity 102A may operate in accordance with any of a number of wireless communication standards and protocols, such as those described above with regard to the computing entity 106. In a particular embodiment, the external computing entity 102A may operate in accordance with multiple wireless communication standards and protocols, such as UMTS, CDMA2000, 1xRTT, WCDMA, GSM, EDGE, TD-SCDMA, LTE, E-UTRAN, EVDO, HSPA, HSDPA, Wi-Fi, Wi-Fi Direct, WiMAX, UWB, IR, NFC, Bluetooth, USB, and/or the like. Similarly, the external computing entity 102A may operate in accordance with multiple wired communication standards and protocols, such as those described above with regard to the computing entity 106 via an external entity network interface 320.

Via these communication standards and protocols, the external computing entity 102A can communicate with various other entities using means such as Unstructured Supplementary Service Data (USSD), Short Message Service (SMS), Multimedia Messaging Service (MMS), Dual-Tone Multi-Frequency Signaling (DTMF), and/or Subscriber Identity Module Dialer (SIM dialer). The external computing entity 102A can also download changes, add-ons, and updates, for instance, to its firmware, software (e.g., including executable instructions, applications, program modules), operating system, and/or the like.

According to one embodiment, the external computing entity 102A may include location determining embodiments, devices, modules, functionalities, and/or the like. For example, the external computing entity 102A may include outdoor positioning embodiments, such as a location module adapted to acquire, for example, latitude, longitude, altitude, geocode, course, direction, heading, speed, universal time (UTC), date, and/or various other information/data. In one embodiment, the location module can acquire data such as ephemeris data, by identifying the number of satellites in view and the relative positions of those satellites (e.g., using global positioning systems (GPS)). The satellites may be a variety of different satellites, including Low Earth Orbit (LEO) satellite systems, Department of Defense (DOD) satellite systems, the European Union Galileo positioning systems, the Chinese Compass navigation systems, Indian Regional Navigational satellite systems, and/or the like. This data can be collected using a variety of coordinate systems, such as the Decimal Degrees (DD); Degrees, Minutes, Seconds (DMS); Universal Transverse Mercator (UTM); Universal Polar Stereographic (UPS) coordinate systems; and/or the like. Alternatively, the location information/data can be determined by triangulating a position of the external computing entity 102A in connection with a variety of other systems, including cellular towers, Wi-Fi access points, and/or the like. Similarly, the external computing entity 102A may include indoor positioning embodiments, such as a location module adapted to acquire, for example, latitude, longitude, altitude, geocode, course, direction, heading, speed, time, date, and/or various other information/data. Some of the indoor systems may use various position or location technologies including RFID tags, indoor beacons or transmitters, Wi-Fi access points, cellular towers, nearby computing devices (e.g., smartphones, laptops) and/or the like. For instance, such technologies may include the iBeacons, Gimbal proximity beacons, Bluetooth Low Energy (BLE) transmitters, NFC transmitters, and/or the like. These indoor positioning embodiments can be used in a variety of settings to determine the location of someone or something to within inches or centimeters.

The external computing entity 102A may include a user interface 316 (e.g., a display, speaker, and/or the like) that can be coupled to the external entity processing element 308. In addition, or alternatively, the external computing entity 102A can include a user input interface 319 (e.g., keypad, touch screen, microphone, and/or the like) coupled to the external entity processing element 308).

For example, the user interface 316 may be a user application, browser, and/or similar words used herein interchangeably executing on and/or accessible via the external computing entity 102A to interact with and/or cause the display, announcement, and/or the like of information/data to a user. The user input interface 318 can comprise any of a number of input devices or interfaces allowing the external computing entity 102A to receive data including, as examples, a keypad (hard or soft), a touch display, voice/speech interfaces, motion interfaces, and/or any other input device. In embodiments including a keypad, the keypad can include (or cause display of) the conventional numeric (0-9) and related keys (#, *, and/or the like), and other keys used for operating the external computing entity 102A and may include a full set of alphabetic keys or set of keys that may be activated to provide a full set of alphanumeric keys. In addition to providing input, the user input interface 318 can be used, for example, to activate or deactivate certain functions, such as screen savers, sleep modes, and/or the like.

The external computing entity 102A can also include one or more external entity non-volatile memories 322 and/or one or more external entity volatile memories 324, which can be embedded within and/or may be removable from the external computing entity 102A. As will be understood, the external entity non-volatile memories 322 and/or the external entity volatile memories 324 may be embodied in a number of different ways including, for example, as described herein with reference to the non-volatile memories 210 and/or the external volatile memories 215.

The terms “data,” “content,” “digital content,” “digital content object,” “signal,” “information,” and similar terms may be used interchangeably to refer to data capable of being transmitted, received, and/or stored in accordance with embodiments of the present disclosure. Thus, use of any such terms should not be taken to limit the spirit and scope of embodiments of the present disclosure. Further, where a computing device is described herein to receive data from another computing device, it will be appreciated that the data may be received directly from another computing device or may be received indirectly via one or more intermediary computing devices, such as, for example, one or more servers, relays, routers, network access points, base stations, hosts, and/or the like, sometimes referred to herein as a “network.” Similarly, where a computing device is described herein to send data to another computing device, it will be appreciated that the data may be transmitted directly to another computing device or may be transmitted indirectly via one or more intermediary computing devices, such as, for example, one or more servers, relays, routers, network access points, base stations, hosts, and/or the like

Many modifications and other embodiments will come to mind to one skilled in the art to which this disclosure pertains having the benefit of the teachings presented in the foregoing descriptions and the associated drawings. Therefore, it is to be understood that the disclosure is not to be limited to the specific embodiments disclosed and that modifications and other embodiments are intended to be included within the scope of the appended claims. Although specific terms are employed herein, they are used in a generic and descriptive sense only and not for purposes of limitation.

1. A method for side-channel leakage evaluation of asymmetric key cryptography algorithms, comprising:
identifying, by one or more processors, inputs, constraints, and a sequence of steps involved in an algorithm of a design specification;
generating, by the one or more processors, input test vectors, wherein the input test vectors are associated with a secrecy guarantee of the algorithm;
generating, by the one or more processors, a testbench for simulation of the design specification;
generating, by the one or more processors, power traces by simulating the design specification;
performing, by the one or more processors, a leakage assessment on generated power profiles using one or more of simple power analysis or differential power analysis;
generating, by the one or more processors and based at least in part on the power traces and leakage assessment, a divergence factor; and
determining, by the one or more processors and based at least in part on the divergence factor, whether the design specification has a side-channel vulnerability.

2. The method of claim 1, further comprising:
responsive to determining that the design specification has a side-channel vulnerability, modifying the design specification to eliminate side-channel leakage.

3. The method of claim 2, wherein modifying the design specification comprises mitigation for scalar multiplication.

4. The method of claim 3, wherein modifying the design specification comprises Montgomery ladder-based implementation.

5. The method of claim 1, further comprising:
dynamically partitioning trace data, wherein dynamically partitioning the trace data improves statistical resolution to reduce type 1 errors and type 2 errors.

6. The method of claim 5, wherein the type 1 errors comprise false positives and the type 2 errors comprise false negatives.

7. The method of claim 1, wherein the algorithm comprises an asymmetric key cryptography algorithm and wherein the method further comprises:
automatically generating directed tests to maximize side-channel sensitivity of the asymmetric key cryptographic algorithm.

8. The method of claim 1, wherein the algorithm comprises an asymmetric key cryptography algorithm and wherein the method further comprises:
automatically identifying each stage in the asymmetric key cryptographic algorithm; and
evaluating a side-channel leakage of each stage.

9. The method of claim 1, further comprising:
evaluating side-channel leakage of a hybrid cryptosystem comprising symmetric key cryptography algorithms and asymmetric key cryptography algorithms.

10. The method of claim 1, wherein the algorithm comprises an asymmetric key cryptography algorithm and the design specification is associated with one of a hardware implementation or firmware implementation of the asymmetric key cryptography algorithm.

11. An apparatus comprising non-transitory computer readable memory storing instructions and one or more processors that, with the instructions, configure the apparatus to:
identify inputs, constraints, and a sequence of steps involved in an algorithm of a design specification;
generate input test vectors, wherein the input test vectors are associated with a secrecy guarantee of the algorithm;
generate a testbench for simulation of the design specification;
generate power traces by simulating the design specification;
perform a leakage assessment on generated power profiles using one or more of simple power analysis or differential power analysis;
generate, based at least in part on the power traces and leakage assessment, a divergence factor; and
determine, based at least in part on the divergence factor, whether the design specification has a side-channel vulnerability.

12. The apparatus of claim 11, wherein the one or more processors and the instructions further configure the apparatus to:
responsive to determining that the design specification has a side-channel vulnerability, modify the design specification to eliminate side-channel leakage.

13. The apparatus of claim 12, wherein modifying the design specification comprises mitigation for scalar multiplication.

14. The apparatus of claim 13, wherein modifying the design specification comprises Montgomery ladder-based implementation.

15. The apparatus of claim 11, wherein the one or more processors and the instructions further configure the apparatus to:
dynamically partition trace data, wherein dynamically partitioning the trace data improves statistical resolution to reduce type 1 errors and type 2 errors, wherein the type 1 errors comprise false positives and the type 2 errors comprise false negatives.

16. The apparatus of claim 11, wherein the algorithm comprises an asymmetric key cryptography algorithm and wherein the one or more processors and the instructions further configure the apparatus to:
automatically generate directed tests to maximize side-channel sensitivity of the asymmetric key cryptographic algorithm.

17. The apparatus of claim 11, wherein the algorithm comprises an asymmetric key cryptography algorithm and wherein the one or more processors and the instructions further configure the apparatus to:
automatically identify each stage in the asymmetric key cryptographic algorithm; and
evaluate a side-channel leakage of each stage.

18. The apparatus of claim 11, wherein the one or more processors and the instructions further configure the apparatus to:
evaluate side-channel leakage of a hybrid cryptosystem comprising symmetric key cryptography algorithms and asymmetric key cryptography algorithms.

19. The apparatus of claim 11, wherein the algorithm comprises an asymmetric key cryptography algorithm and the design specification is associated with one of a hardware implementation or firmware implementation of the asymmetric key cryptography algorithm.

20. A non-transitory computer readable storage medium comprising instructions that, when executed by one or more processors, cause the one or more processors to:
identify inputs, constraints, and a sequence of steps involved in an algorithm of a design specification;
generate input test vectors, wherein the input test vectors are associated with a secrecy guarantee of the algorithm;
generate a testbench for simulation of the design specification;
generate power traces by simulating the design specification;
perform a leakage assessment on generated power profiles using one or more of simple power analysis or differential power analysis;
generate, based at least in part on the power traces and leakage assessment, a divergence factor; and
determine, based at least in part on the divergence factor, whether the design specification has a side-channel vulnerability.
